(19) United States
(12) Patent Application Publication
(10) Pub. No.: US 2006/0000084 A1
(43) Pub. Date: Jan. 5, 2006

(54) Nozzle of surface mount device

(75) Inventor: Hsien-Tsung Chiu, Taipei (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: Inventec Corporation, Taipei (TW)

(21) Appl. No.: 10/880,924

(22) Filed: Jun. 30, 2004

(51) Int. Cl. A47J 45/00

(52) U.S. Cl. 29/743; 294/64.1

(57) ABSTRACT

A nozzle of a surface mount device (“SMD”) includes a shaft and a sleeve. The shaft includes a passage at an end and a passage at an opposite end. The passages are communicated for communicating air. The sleeve includes, at an end, a seat engaged with the shaft and, at an opposite end, an enlarged opening. The enlarged opening and an external diameter of the sleeve form a sucking surface. Because of the friction of sleeve of the nozzle with electronic components, a sleeve of a single can substitute for a plurality of nozzles of different sizes in order to reduce the frequency of replacement of nozzles.

### BACKGROUND OF THE INVENTION

(a) Field of the Invention

The present invention relates to a component of a surface mount device and, more particularly, to a nozzle of a module-packing system for use in a multi-function chip-mounting device.

(b) Description of the Related Art

During a packing procedure, a sucking type nozzle is used for taking up and putting down electronic components. Referring to FIG. 1, a conventional nozzle 100 includes a shaft 110, a positioning bar 120 and an elastomer 130. The shaft 110 axially defines a passage 111. The positioning bar 120 is made of metal. In an upper end, the positioning bar 120 includes a seat 121 fit around the shaft 110. In a lower end, the positioning bar 120 defines a chamber 123 of an enlarged diameter. The elastomer 130 is put in the chamber 123 and extends from the lower end of the positioning bar 120 by a proper distance. The elastomer 130 centrally defines a passage 131 communicated with the passage 111 of the shaft 110.

When the nozzle 100 sucks an IC chip 400, the elastomer 130 contacts the IC chip 400. When the passages 111 and 131 start to suck, the elastomer 130 becomes a sucking surface and sucks the IC chip 400.

Although the nozzle 100 can suck the IC chip 400, the external size of the positioning bar 120 is designed so that it is generally suitable only for IC chips 400 of a size. This is because the elastomer 130 is compressed and deformed when it contacts the IC chips 400, and the lower end 124 of the positioning bar 120 contacts the IC chips 400 in order to ensure that the IC chips 400 are positioned horizontally. The IC chips 400 are often different from one another in size so that a printed circuit board requires several nozzles 100 of different sizes. As shown, the surface mount device generally includes six replacement seats for receiving six nozzles 100 of different sizes. A round of replacing a nozzle 100 takes about three seconds. A program design generally requires three to four rounds of replacement, taking about 1/15 of total time. Hence, a high frequency of replacement affects throughput. Moreover, because the positioning bar 120 is made of hard metal, the thickness of the wall of the chamber in the lower end 124 of the positioning bar 120 is generally thick. The contact surface with an IC chip 400 is small. Hence, the friction is small. When the IC chip 400 is sucked and moved, inertia against the start and stop is weak. Hence, the electronic component can easily be aligned poorly and even dropped, thus affecting the packing procedure.

The present invention is therefore intended to obviate or at least alleviate the problems encountered in prior art.

### SUMMARY OF THE INVENTION

It is an objective of the present invention to provide a nozzle of surface mount device including a shaft and a sleeve suitable for electronic components of different sizes, thus reducing the frequency in replacement of nozzles in a packing procedure.

It is another objective of the present invention to provide a nozzle of surface mount device including a shaft and a sleeve for increasing friction with electronic components in order to increase the stability in positioning the electronic components and reducing suck impact on the electronic components, thus avoiding scratching and damaging the electronic components.

To achieve the above-mentioned objectives, the present invention provides a nozzle of surface mount device. The nozzle includes a shaft and a sleeve. The shaft defines a passage at an end and at least one passage at an opposite end. The passages are communicated for communicating air. The sleeve includes a seat for engagement with the shaft and an enlarged opening at an opposite end. The enlarged opening and the external diameter of the sleeve form a sucking surface. The sleeve provides an increased sucking surface for electronic components. While sucking electronic components, the sleeve, that includes the increased sucking surface, is suitable for electronic components of different sizes. Moreover, the sleeve includes increased sucking surface friction and elasticity, and is fit around the shaft. While sucking electronic components, the sleeve, that includes the increased contact surface friction, provides a better sucking force, and increases the stability in positioning. Moreover, the sleeve, that is elastic, can reduce sucking impact on electronic components.

Other objects, advantages and novel features of the present invention will become more apparent from the following detailed description referring to the attached drawings.

### BRIEF DESCRIPTION OF THE DRAWINGS

The present invention will be described via detailed illustration of the preferred embodiment referring to the drawings.

FIG. 1 is a perspective view of a conventional nozzle of a surface mount device.

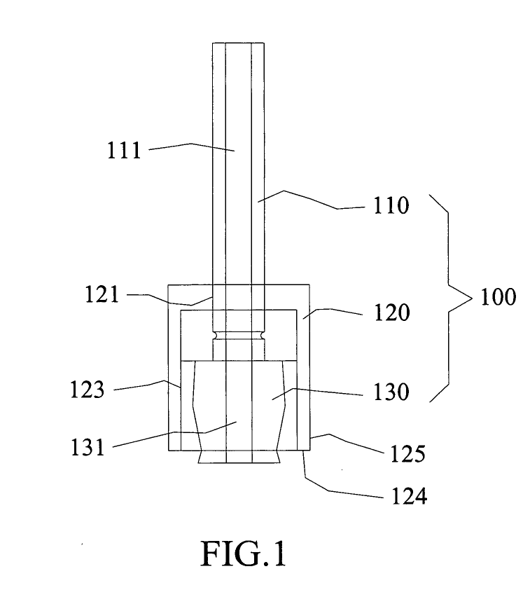

FIG. 2 is an exploded view of a nozzle of a surface mount device according to the preferred embodiment of the present invention.

FIG. 3 is the relation of a sleeve of the nozzle of FIG. 2 with IC chips of different sizes.

### PREFERRED EMBODIMENTS OF THE INVENTION

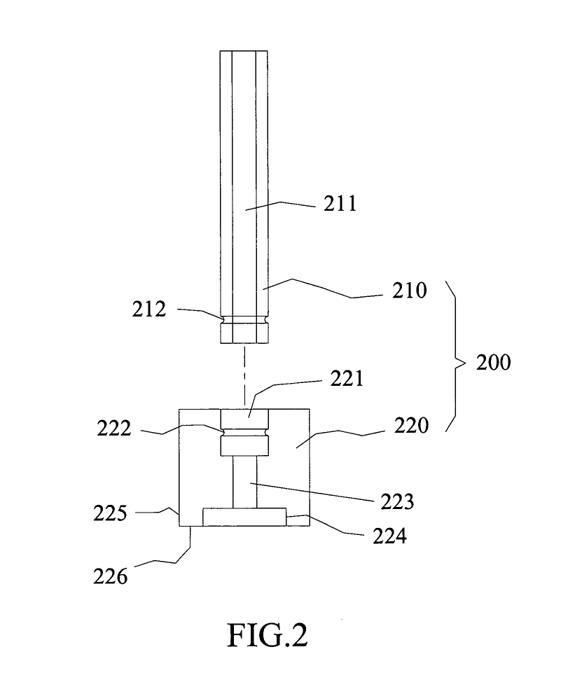

Referring to FIG. 2, according to the preferred embodiment of the present invention, a nozzle 200 includes a shaft 210 and a sleeve 220. The shaft 210 defines a passage 211 and a recess 212. The sleeve 220 is made of rubber. The sleeve 220 includes a seat 221 and a protrusion 222 at an end. The seat 221 is engaged with the shaft 210. The protrusion 222 corresponds to the recess 212 of the shaft 210. When the seat 221 is engaged with the shaft 210, the protrusion 222 is fit in the recess 212 for positioning. The sleeve 220 defines a passage 223 at an opposite end. The passage 223 is communicated with the passage 211 of the shaft 210. The passage 223 of the sleeve 220 becomes an enlarged opening 224 at a lower end. The enlarged opening 224 and an external diameter 225 of the sleeve form a sucking surface 226. The sleeve 220 must be fit around the shaft 210 so that the nozzle 200 includes a sucking surface 226. When the passages 211 and 223 suck, the sucking surface 226 provides adequate friction for sucking the IC chip 400. When the passages 211 and 223 expel, the sucking is terminated and the IC chip 400 is released.

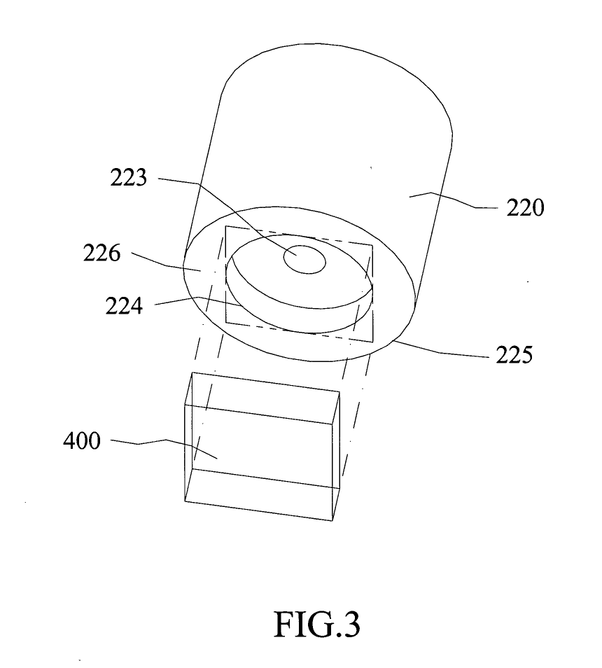

The advantage of the present invention is ability to suck IC chips 400 of different sizes. Referring to FIG. 3, the enlarged opening 224 of the sleeve 220 and the external diameter 225 define the range of the sucking surface 226. As long as an IC chip 400 is covered by the enlarged opening 224, effective sucking is possible. According to our experiments, the sleeve 220 can effectively suck IC chips 400 of different sizes. When the enlarged opening 224 of the sleeve 220 is ψ7 and the external diameter 225 is ψ11, the nozzle 200 can substitute for positioning bars 120 with external diameters of ψ7 to ψ15.

As discussed above, the present invention is not limited to the sizes of the IC chips 400. The nozzle 200 of a size is suitable for the IC chips 400 of similar diameters. That is, a nozzle 200 of a size substitutes for a plurality of conventional nozzles 100. Thus, stock of parts can be reduced effectively in order to reduce the production cost. In addition, because of the special design of the contact surface of the nozzle 200, stability in movement of the IC chips 400 is improved. The sleeve 220 is made of rubber to avoid damaging the IC chips 400. As mentioned, the effect of present invention is better than that of the conventional nozzle 100.

The present invention has been described via detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A nozzle of a surface mount device, said nozzle comprising:
a shaft defining a passage at an end and a passage at an opposite end; and
a sleeve comprising, at an end, a seat engaged with said shaft and, at an opposite end, a passage communicated with said passage of said shaft, wherein said passage of said sleeve becomes an enlarged opening at a lower end, wherein said enlarged opening and an external diameter of said sleeve form a sucking surface for sucking electronic components.

2. The nozzle according to claim 1 wherein said sleeve is an elastomer.

3. The nozzle according to claim 2 wherein said elastomer is made of rubber or silicone.

4. The nozzle according to claim 1 wherein said shaft comprises a recess by means of which said seat is firmly engaged with said shaft.

5. The nozzle according to claim 4 wherein said seat comprises a restraint by means of which said seat is firmly engaged with said shaft.

6. The nozzle according to claim 5 wherein said restraint is a protrusion formed on said seat.

7. The nozzle according to claim 1 wherein said electronic components are IC chips.
